(19) United States
(12) Patent Application Publication
(10) Pub. No.: US 2008/0123595 A1
(43) Pub. Date: May 29, 2008

(54) Method And System Of Wireless Communications

(76) Inventors: Christofer Lindheimer, Kista (SE); Anders Milen, Nacka (SE); Petter Blomberg, Sundbyberg (SE); Patrik Karlsson, Alta (SE)

Correspondence Address: ERICSSON INC., 6300 LEGACY DRIVE, M/S EVR 1-C-11, PLANO, TX, 75024, US

(21) Appl. No.: 11/721,790

(22) PCT Filed: Dec. 30, 2004
(86) PCT No.: PCT/SE04/02060

§ 371 Date: Jun. 14, 2007

(51) Int. Cl. H04Q 7/00; G08C 17/00

(52) U.S. Cl. 370/331; 370/311; 455/442; 370/278; 455/522

(57) ABSTRACT

The present invention relates to wireless communications. More especially it relates to wireless high speed packet data communications. Particularly it relates to transmission power control of high speed packet data communications including adjustment of one or more transmission power control parameters of one or more wireless links not involved in soft handover in relation to wireless one or more links involved in soft handover or coordination of such parameters.

### TECHNICAL FIELD OF THE INVENTION

The present invention relates to wireless communications. More especially it relates to wireless high speed packet data communications. Particularly it relates to transmission power control of high-speed packet data communications.

### BACKGROUND AND DESCRIPTION OF RELATED ART

Transmission power control of dedicated and shared channels, such as DPDCH (Dedicated Physical Data Channel) and DPCCH (Dedicated Physical Control Channel) in UMTS (Universal Mobile Telecommunications System), is previously known.

FIG. 1 shows schematically selected elements of a UMTS communications system according to prior art. Protocol Data Units, PDUs, are communicated downlink, DL, to user equipment <<UE>> and uplink from the user equipment <<UE>>. Information disassembled/reassembled into appropriately sized protocol data units <<PDU>> are transferred to a presumed receiver. The communications path involves a radio base station, RBS, <<BS1/Node B 1>> and a radio network controller <<RNC>>, the radio base station <<BS1/Node B 1>> is connected to the RNC over an Iub interface and to the UE over a radio interface. Also depicted is a second radio base station <<BS2/Node B 2>> not participating in the particular information transfer at the time instant depicted in the figure. Node B is a logical node responsible for radio transmission/reception in one or more cells to/from a User Equipment. A base station, BS, or radio base station is a physical entity representing Node B.

FIG. 2 displays schematically selected elements involved in soft handover diversity in a UMTS communications system according to prior art. In uplink direction, PDUs, transmitted from UE are received over different radio links, illustrated by two radio base stations <<BS 1/Node B 1>> <<BS 2/Node B 2>> receiving transmitted protocol data units <<PDU>> over the radio interface. The protocol data units are forwarded to radio network controller <<RNC>>. RNC combines received PDUs according to selection diversity combining. In downlink direction protocol data units are transferred to UE over the radio network controller <<RNC>> and the two radio base stations <<BS 1/Node B 1>> <<BS 2/Node B 2>>. Identical PDUs transmitted over the radio interface from the radio base stations <<BS 1/Node B 1>> <<BS 2/Node B 2>> are combined in the receiver of UE.

FIG. 3 shows a layered protocol structure, a protocol stack for HS-DSCH. The L2 MAC layer is divided into two sub-layers, an L2 MAC sub-layer and a MAC-hs sub-layer. The MAC-hs plus the MAC layer could be regarded as one single MAC layer extended to also include hybrid ARQ (Automatic Repeat Request), HARQ, functionality, allowing combining of successively received (re-)transmissions. However, for reasons of explanation they are preferably regarded as separate sub-layers. Further, on the network side, considering them as separate protocol sub-layers physically better corresponds to the physical entities where they reside. As illustrated in FIG. 3 on the UTRAN-side (or network side) L2 MAC sub-layer is preferably located in RNC, whereas L2 MAC-hs sub-layer is located in Node B. As the hybrid ARQ protocol combines successively received retransmissions it is a great advantage to have this protocol close to the physical layer and, particularly, in Node B. RLC/MAC control blocks are used to transport RLC/MAC control messages. In an RLC/MAC control block, all transported segments are of the same RLC/MAC control message. RLC/MAC control blocks are sent at a higher priority than RLC data blocks. RLC/MAC control blocks are sent on ADCH (Associated Dedicated Channel).

3^{rd} Generation Partnership Project (3GPP): Technical Specification Group Radio Access Network, Physical Layer Procedures, 3G TS 25.301 v3.6.0, France, September 2000, specifies in chapter 5 Radio Interface Protocol Architecture of a UMTS system. There are three protocol layers:
physical layer, layer 1 or L1,
data link layer, layer 2 or L2, and
network layer, layer 3 or L3.

Layer 2, L2, and layer 3, L3 are divided into Control and User Planes. Layer 2 consists of two sub-layers, RLC and MAC, for the Control Plane and four sub-layers, BMC, PDCP, RLC and MAC, for the User Plane. The acronyms BMC, PDCP, RLC and MAC denote Broadcast/Multicast Control, Packet Data Convergence Protocol, Radio Link Control and Medium Access Control respectively.

3^{rd} Generation Partnership Project (3GPP): Technical Specification Group Radio Access Network, Spreading and modulation (FDD) (Release 6), 3GPP TS 25.213 v6.0.0, France, December 2003, describes spreading and modulation for UTRA (Universal Terrestrial Radio Access) Physical Layer FDD (Frequency Division Duplex) mode. Section 4.2 of the Technical Specification describes uplink spreading of, e.g., DPCCH, DPDCHs and HS-DPCCH (High Speed Dedicated Physical Control Channel). HS-DPCCH is a control channel (in uplink direction) for HSDPA (High Speed Downlink Packet Access) carrying feedback information. After channelization, the real-valued spread signals are weighted by gain factors, β_{c} for DPCCH, β_{d} for all DPDCHs and βₕₛ for HS-DPCCH (if one is active). The β_{c} and β_{d} values are signaled by higher layers or calculated. At every instant in time, at least one of the values β_{c} and β_{d} has the amplitude 1.0. The β_{c} and β_{d} values are quantized into 4-bit words corresponding to the nominator of a rational number with 15 in the denominator.

3^{rd} Generation Partnership Project (3GPP) Technical Specification Group Radio Access Network, Physical layer procedures (FDD), (Release 6), 3GPP TS 25.214 v6.3.0, France, September 2004, specifies and establishes the characteristics of the physicals layer procedures in the FDD mode of UTRA. Paragraph 5.1.2.5A defines setting of uplink DPCCH/HS-DPCCH power difference. When an HS-DPCCH is active, the power offset Δ_{HS-DPCCH} for each HS-DPCCH slot shall be set as follows. For HS-DPCCH slots carrying HARQ Acknowledgement:
Δ_{HS-DPCCH}=Δ_{ACK} if the corresponding HARQ Acknowledgement is equal to 1.
Δ_{HS-DPCCH}=Δ_{NACK} if the corresponding HARQ Acknowledgement is equal to 0.

For HS-DPCCH slots carrying CQI:
Δ_{HS-DPCCH}=Δ_{CQI}

The values for Δ_{ACK}, Δ_{NACK} and Δ_{CQI} are set by higher layers. Then, in non-compressed frames, the gain factor βₕₛ is calculated according to

βₕₛ=β_{c}·10^{Δ}_{HS-DPCCH}/20,

where β_{c} value is signaled by higher-layer or calculated as described in the technical specification. During the period between the start and end of a compressed DPCCH frame, when HS-DPCCH is transmitted, βₕₛ is calculated according to

$${β}_{hs} = {β}_{c , C , j} \cdot {10}^{{Δ}_{HS \text{-} DPCCH} / 20} \cdot \sqrt{\frac{{N}_{pilot , C}}{{N}_{pilot , N}}} ,$$

where β_{c,c,j} is calculated as described in the technical specification, N_{pilot,c} is the number of pilot bits per slot on the DPCCH in compressed frames, and N_{pilot,N} is the number of pilot bits per slot in non-compressed frames.

Thus the gain factor βₕₛ varies depending on the current power offset Δ_{HS-DPCCH} and on whether the uplink DPCCH is currently in a compressed frame.

3^{rd} Generation Partnership Project (3GPP): Technical Specification Group Radio Access Network, UTRAN Iub interface NBAP signalling (Release 6), 3GPP TS 25.433 v6.3.0, France, September 2004, specifies the radio network layer signaling protocol called Node B Application Part, NBAP, specification to be used for Control Plane over Iub Interface. A number of information elements, IEs, are explained:
The CQI Power Offset, Δ_{CQI}, IE indicates Power offset used in the UL between the HS-DPCCH slots carrying CQI (Channel Quality Indication) information and the associated DPCCH.
The NACK Power Offset, Δ_{NACK}, IE indicates Power offset used in the UL between the HS-DPCCH slot carrying HARQ NACK information and the associated DPCCH.
The ACK Power Offset, Δ_{ACK}, IE indicates Power offset used in the UL between the HS-DPCCH slot carrying HARQ ACK information and the associated DPCCH.
The CQI Repetition Factor IE indicates the number of consecutive repetitions of the CQI.
The CQI Feedback Cycle k IE provides the duration of the CQI feedback cycle.
The ACK-NACK Repetition Factor IE indicates the number of consecutive repetitions of the ACK and NACK.

According to 3GPP TS 25.433 it shall be possible to initiate changes to CQI repetition factor and feedback cycle, as well as ACK-NACK repetition factors from Radio Link Parameter update. The Radio Link Parameter Update procedure is executed by the Node B when the update of HS-DSCH related radio link parameter values are needed on the Node B side. With this procedure, Node B can suggest some HS-DSCH related Radio Link Parameter values to RNC. In FDD (Frequency Division Duplex) mode, if Node B needs to update the CQI Feedback Cycle k, CQI Repetition Factor, ACK-NACK Repetition Factor, CQI Power Offset, ACK Power Offset and/or NACK Power Offset, the Node B shall initiate RADIO LINK PARAMETER UPDATE INDICATION message including CQI Feedback Cycle k IE, CQI Repetition Factor IE, ACK-NACK Repetition Factor IE, CQI Power Offset IE, ACK Power Offset IE and/or NACK Power Offset IE.

European Telecommunications Standards Institute 2004: ETSI TS 125 401 V5.9.0, Universal Mobile Telecommunications System (UMTS); UTRAN overall description (3GPP TS 25.401 version 5.9.0 Release 5), France, September 2004, lists in section 3 a number of definitions and abbreviations, and defines a radio link as a logical association between a single User Equipment and a single UTRAN access point. Its physical realization comprises one or more radio bearer transmissions. A Radio Link Set, RLS, is a set of one or more Radio Links that has a common generation of Transmit Power Control, TPC, commands in the DL. A UTRAN Access Point is a conceptual point within the UTRAN performing radio transmission and reception. A UTRAN access point is associated with one specific cell, i.e. there exists one UTRAN access point for each cell. It is the UTRAN-side end point of a radio link.

None of the cited documents above discloses a method and system of adjusting transmission power control parameters of one or more wireless links not involved in soft handover in relation to wireless one or more links involved in soft handover or coordination of such parameters.

### SUMMARY OF THE INVENTION

Setting of transmission power control offsets for HS-DPCCH as an example from the UMTS specification, when the number of links involved for HS-DPCCH coincides with the number of links for the channel, typically DPCCH, or channels, such as DPCCH and DPDCH, to which the power offset relates is straight forward, at least as long as the links are served by the same base station. However, in soft handover situations or in situations where the links are served by different base station, prior art solution imposes problems.

The ADCH can be in soft handover, like any other ordinary DCH. HSDPA and HS-DSCH cannot. When the ADCH is communicating with more than one cell in a soft handover situation it is power controlled by outer loop and inner loop power control. The reference for βₕₛ is either DPDCH or DPCCH, or both. In the uplink DPDCH and DPCCH are power controlled by the outer and inner loop. During soft handover, the fact that DPDCH and DPCCH perceive a diversity effect is considered in the inner and outer loop power control. The information on DPDCH concerning outer loop power control is terminated in RNC. HS-DPCCH is terminated in Node B serving a present user equipment entity. Consequently, according to prior art it is power controlled as if it would enjoy a diversity effect corresponding to DPCCH or DPDCH when in soft handover, when it actually perceives no diversity gain, since it communicates over a single diversity branch. During soft handover there is consequently a great risk that channel quality of HS-DPCCH can seriously degrade, which jeopardizes both ARQ feedback and CQI information to the HS scheduling entity.

Consequently, there is a need of providing uplink transmission power control compensating for diversity mismatch between various links, sharing control parameters.

An object of embodiments of the invention is to compensate transmission power control of uplink physical channels sharing one or more power control parameters, in relation to the number of radio links involved in a connection.

Another object is to provide transmission power control by means of a limited number of transmission power control parameters, for uplink physical channels of different diversity order.

It is also an object of embodiments of the invention to provide a method and system for efficient signaling of transmission power control.

Finally, it is an object of embodiments of the invention to provide a method and system for signaling of transmission power control optimized for parameter matching.

These objects are met by a method and system of updating uplink power offset parameters, determining a transmission power offset of different uplink physical channels depending on the cardinality of Radio Link Set, RLS, or number of radio base stations, RBSes, in an active set; or predefined error-patterns received in one or more of the base stations.

### BRIEF DESCRIPTION OF THE DRAWINGS

FIG. 1 shows schematically selected elements of a UMTS communications system according to prior art.

FIG. 2 displays schematically selected elements involved in soft handover diversity in a UMTS communications system according to prior art.

FIG. 3 shows a layered protocol structure, a protocol stack for HS-DSCH according to prior art.

FIG. 4 illustrates an active set comprising three radio links involving user equipment <<UE>> and three radio base stations <<BS 2>>, <<BS 3>>, <<BS 4>> during a soft handover.

FIG. 5 shows uplink channel structure of ADCH. For high-speed communications an HS-DPCCH is included.

FIG. 6 depicts signaling triggered by RBS according to a first mode of the invention.

FIG. 7 monitors signaling triggered by RNC according to a second mode of the invention.

FIG. 8 illustrates schematically in a flow chart parameter updating according to the first mode of the invention.

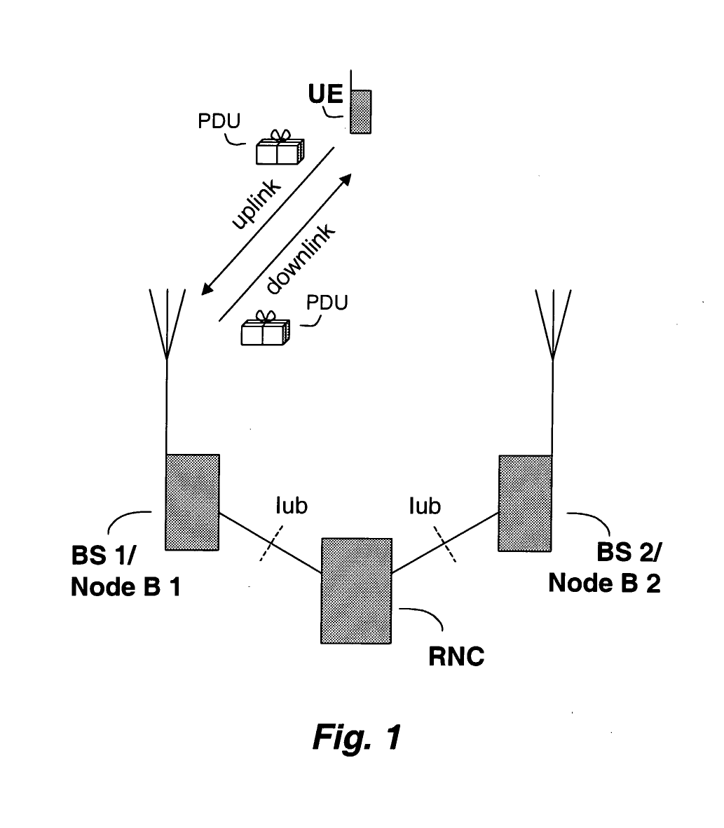

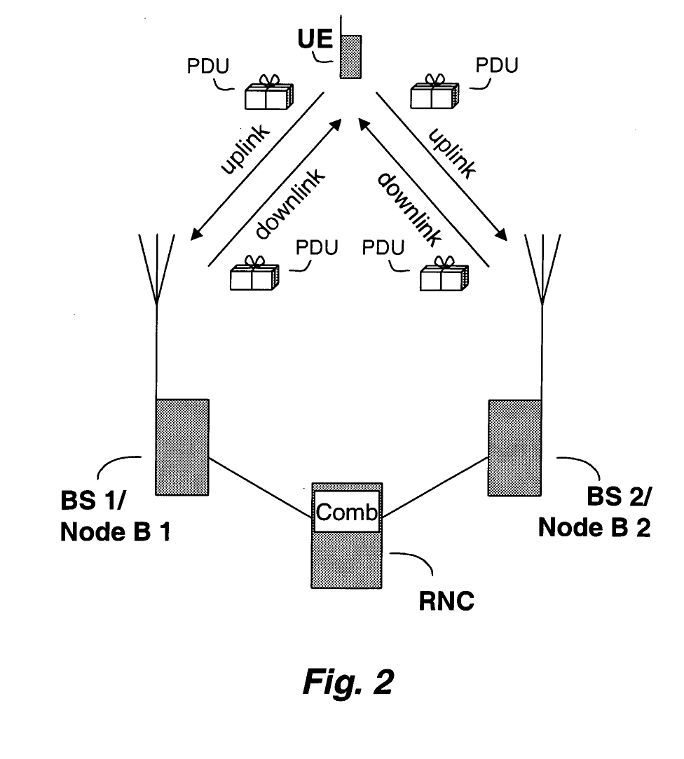

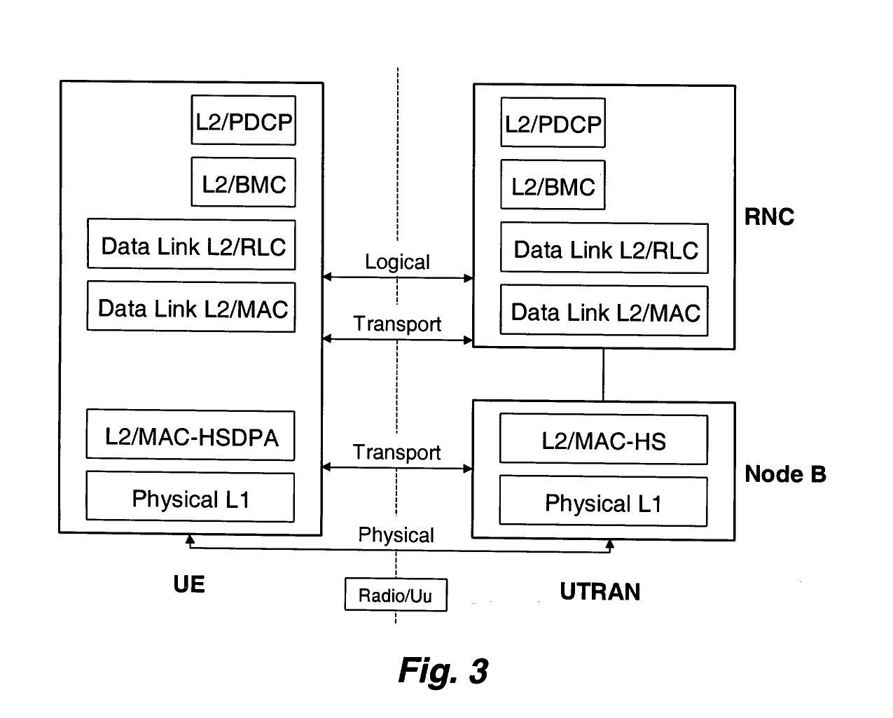

### DESCRIPTION OF PREFERRED EMBODIMENTS

Setting of transmission power control offsets for HS-DPCCH as an example from the UMTS specification, when the number of links involved for HS-DPCCH coincides with the number of links for the channel, typically DPCCH, or channels, such as DPCCH and DPDCH, to which the power offset relates is straight forward, at least as long as the links are served by the same base station. However, in soft handover situations or in situations where the links are served by different base station, prior art solution imposes problems.

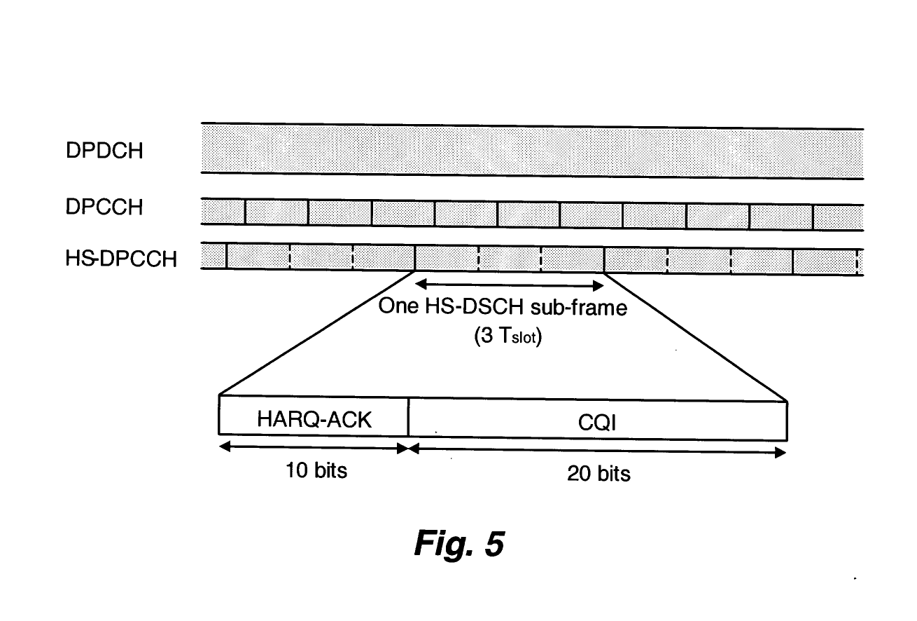

FIG. 5 shows uplink channel structure of ADCH (Associated Downlink Control Channel). For high-speed communications an HS-DPCCH (High-Speed Dedicated Physical Control Channel) is included. HS-DPCCH carries, e.g., feedback information requesting retransmission or (positively) acknowledging successfully received transmissions <<HARQ-ACK>> and channel quality information <<CQI>> destined for MAC-hs protocol layer. In UMTS the HARQ-ACK field of an HS-DSCH sub-frame comprises 10 bits, and the CQI field 20 bits, the sub-frame being transmitted over three time slots. The HS-DPCCH is multiplexed with other channels on ADCH. DPCCH and DPDCH are examples of ordinary channels multiplexed on ADCH, together with HS-DPCCH. The ADCH can be in soft handover, like any ordinary DCH.

Since downlink scheduling of HS-DSCH relies on CQI feedback information, transmitted on HS-DPCCH, downlink transmissions could be substantially deteriorated if transmission power of HS-DPCCH is not appropriately adjusted in relation to other physical channels, such as DPDCH and DPCCH, multiplexed on ADCH.

When the ADCH is communicating with more than one cell in a soft handover situation it is power controlled by outer loop and inner loop power control. The reference for βₕₛ is either DPDCH or DPCCH, or both. In the uplink DPDCH and DPCCH are power controlled by the outer and inner loop. During soft handover, the fact that DPDCH and DPCCH perceive a diversity effect is considered in the inner and outer loop power control. The information on DPDCH concerning outer loop power control is terminated in RNC. HS-DPCCH is terminated in Node B serving an entity of user equipment for consideration. Consequently, according to prior art it is power controlled as if it would enjoy a diversity effect of multiple communications links corresponding to DPCCH or DPDCH when in soft handover, when it actually perceives no diversity gain, since it communicates over a single communications link. During soft handover there is consequently a great risk that channel quality of HS-DPCCH seriously degrade, which jeopardizes both ARQ feedback and CQI information to the HS (high speed) scheduling entity and there is a great risk that no feedback information reaches Node B for downlink scheduling and ARQ acknowledgments, which risks to deteriorate downlink performance substantially.

An active set of a connection including an entity of user equipment comprises all radio base stations, RBSes, involved in the connection, whereas a radio link set is a set of one or more Radio Links that has a common generation of TPC commands in the DL. Often the Active Set and the Radio Link Set are identical. In softer handover they are not. In softer handover there are a plurality of radio links of one single radio base station.

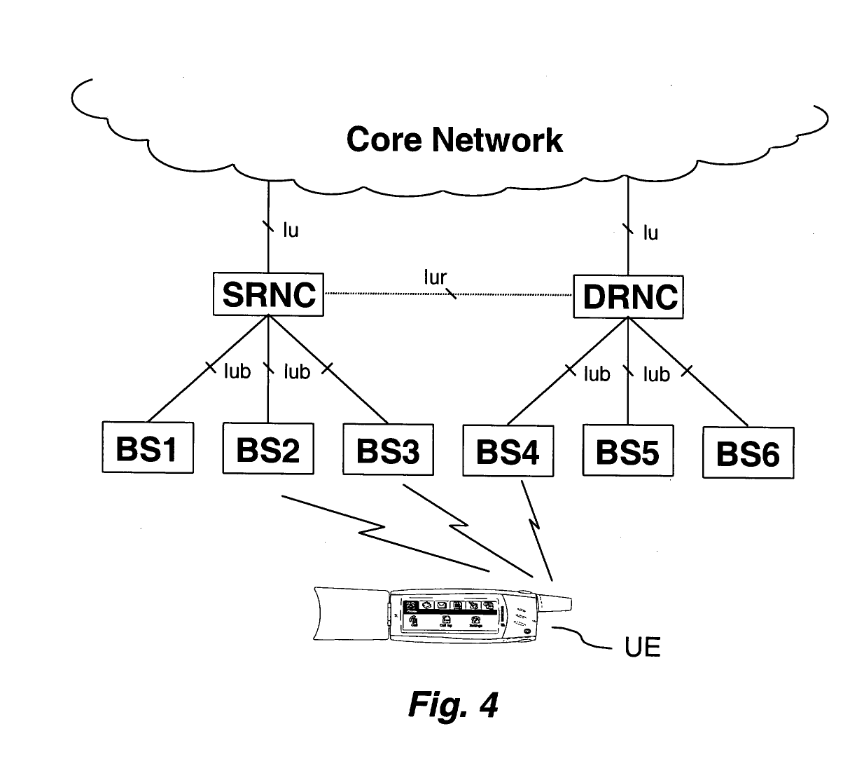

FIG. 4 illustrates an active set comprising three radio links involving user equipment <<UE>> and three radio base stations <<BS 2>>, <<BS 3>>, <<BS 4>> during a soft handover. The radio base stations are controlled by different radio network controllers <<SRNC>> <<DRNC>> over Iub interfaces. The serving RNC <<SRNC>> is the RNC responsible for interconnecting to a core network over an Iu interface. The drift RNC <<DRNC>> assists the SRNC during the soft handover as it controls two of the base stations <<BS 3>>, <<BS 4>> involved. The RNCs <<SRNC>>, <<DRNC>> are interconnected over an Iur interface.

According to a first embodiment of the invention, for a connection the discriminating number of diversity branches for ADCH/DPCCH/DPDCH and HS-DPCCH is considered when determining gain factor βₕₛ, and βₕₛ is updated whenever there is an increase in number of links in the active set or radio link set of the connection. When updating βₕₛ, this is preferably made by increasing the constant power offset for the HS-DPCCH during the time at which the DPDCH relies on gains from macro-diversity.

According to a second embodiment of the invention, repetition factors for HS-DPCCH transmissions (CQI and ACK-NACK repetition factors) are updated. Of course, increased repetition factors implies increased load of control signaling. Preferably the repetition factors are not updated until uplink performance has deteriorated below a threshold. The uplink performance degradation is preferably detected from number of repeated transmission failures and retransmissions in the base station/Node B. Either common or disjoint one or more triggers are used for updating of different repetition factors.

The repetition factors may interfere with CQI feedback cycle (the frequency with which a UE reports CQI). Therefore the repetition factor updating is preferably coordinated with the CQI feedback cycle according to the invention.

According to the first embodiment of the invention, parameters for ADCH are signaled to RBS in Radio Link Reconfiguration and Radio Bearer Setup messages in the radio bearer setup procedure. Parameters related to CQI, such as Δ_{CQI}, CQI repetition factor and CQI feedback cycle, are signaled to UE in downlink HS-PDSCH information message as Measurement Feedback info. Parameters related to ACK/NACK, such as Δ_{ACK}, Δ_{NACK} and ACK-NACK repetition factor, are included as Uplink DPCH power control info fields.

There are two modes of signaling according to the invention. The first mode adopts a synchronized procedure for parameter updating, and the second an unsynchronized procedure. According to the invention, a particular mode is preferably selected conditionally depending on the particular parameters.

The first mode is required when CQI repetition factor, CQI feedback cycle or ACK-NACK repetition factors are to be changed, whereas both modes are applicable for changing of power offsets. Preferably, parameter updating according to the second embodiment triggered from RBS will be signaled according to the first mode of signaling and parameter updating according to the first embodiment related to radio link set size updates will be signaled according to the second mode of signaling.

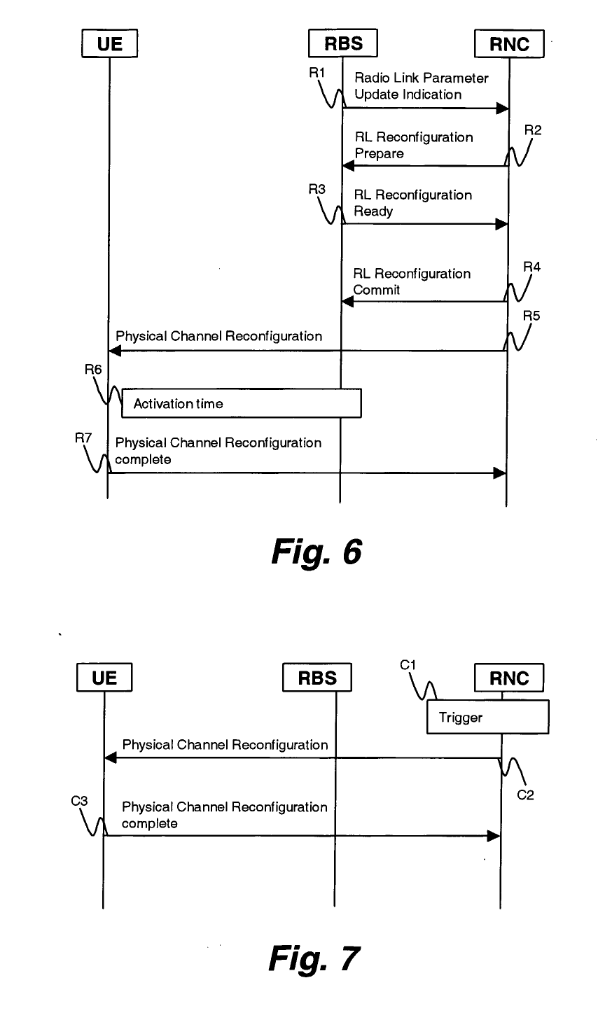

FIG. 6 depicts signaling triggered by RBS according to the first mode. Parameter update, e.g. of CQI repetition factor, CQI feedback cycle and ACK-NACK repetition factor are triggered by radio base station <<RBS>> by sending of an RL Parameter Update Indication <<R1>> to the controlling RNC. At RL Reconfiguration Prepare <<R2>> new values of repetition factors are sent to the RBS with the serving HS-DSCH connection. With RL Reconfiguration Ready signal <<R3>>, new values are stored in RBS. Activation time, in terms of CFN (Connection Frame Number), is then calculated in RNC and sent to RBS <<R4>> in an RL Reconfiguration Commit signal. (Node B, RNC and UE uses CFN for DCH and Common Transport Channels frame transport references.) RNC sends <<R5>> the new one or more parameters, including activation time, in terms of CFN, to UE over RBS. At activation time <<R6>> the new parameters are in effect. A Physical Channel Reconfiguration Complete signal confirms/completes the physical channel reconfiguration.

FIG. 7 monitors signaling triggered by RNC according to the second mode. Subsequent to triggering <<C1>> of updating of one or more transmission power control related parameters Δ_{ACK}, Δ_{NACK} and Δ_{CQI}, new parameters are sent to UE over RBS in Physical Channel Reconfiguration signaling <<C2>>. UE confirms reception and parameter updating in Physical Channel Reconfiguration complete signaling.

According to the first mode, Node B initiates parameter update preferably when detecting particular CQI error patterns of received CQI, each non-reliable CQI being logged as a CQI error event, if at least one updated parameter (CQI repetition factor or ACK-NACK repetition factor) differs from the existing parameters. During soft handover or diversity combining, if CQI repetition factor is greater than 1 errors in CQI after combining of diversity branches is considered for logging, not errors in individual CQIs of the various diversity branches or repetitions of particular one or more CQIs. Preferred error patterns for triggering of HS-DPCCH parameter change are listed in table 1 together with preferred parameter settings. In the table cqiErrors refers to a predefined number of consecutive CQI error events, and cqiErrorsAbsent a predefined number of received consecutive one or more CQIs in absence of CQI error event.

TABLE 1

| | | ACK-NACK | CQI |
|---|---|---|---|
| Error | CQI repetition | repetition | feedback |
| Pattern | factor, n_{c} | factor, nₐ | cycle [ms] |
| more than | Min{4, n_{c}_{_{—}}ₚᵣₑᵥ + 1} | Min{4, nₐ_{_{—}}ₚᵣₑᵥ + 1} | >2 · CQI |
| cqiErrors | | | repetition |
| consecutive CQI | | | factor* |
| error events | | | |
| at least | Min{1, n_{c}_{_{—}}ₚᵣₑᵥ − 1} | Min{1, nₐ_{_{—}}ₚᵣₑᵥ − 1} | no change |
| cqiErrorsAbsent | | | |
| consecutive CQI | | | |
| arrivals in | | | |
| absence of CQI | | | |
| error events | | | |

*repetition factor - feedback cycle consistency check

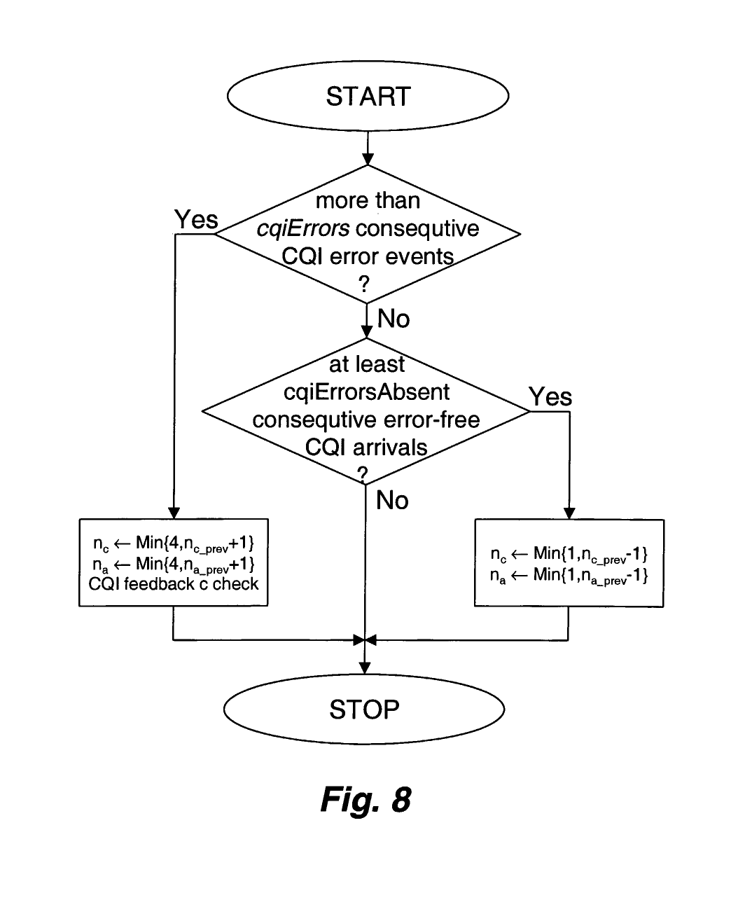

n_{c}_{_{—}}ₚᵣₑᵥ and nₐ_{_{—}}ₚᵣₑᵥ in table 1 refer to the (existing) CQI repetition factor the (existing) ACK-NACK repetition factor, respectively, applied when the parameter update was triggered by a detected error pattern in the first column of table 1. If there are more than cqiErrors consecutive CQI error events and if n_{c}, the updated CQI repetition factor, differs from n_{c}_{_{—}}ₚᵣₑᵥ, the CQI feedback cycle is updated if a repetition factor—feedback cycle consistency check indicates a conflict of the updated CQI repetition factor and existing CQI feedback cycle. In case the consistency check indicates a conflict, CQI feedback cycle is increased. Preferably the updated CQI feedback cycle, measured in milliseconds, is set to 2 times the CQI repetition factor. Preferably there is no corresponding decrease of CQI feedback cycle when CQI repetition factor is decreased as a CQI repetition factor decrease will generally not cause any CQI feedback cycle consistency problem. The invention, however, does not exclude a corresponding decrease of CQI feedback cycle. The procedure is illustrated schematically in a flow chart in FIG. 8.

When the signaling message Radio Link Parameter Update Indication has been sent to the RNC, counters of number of continuous CQI error events and number of continuous error free CQI arrivals are reset. Subsequent to the reset of the counters, there is preferably an interrupt time duration during which the counters are not updated in order to provide some time for RNC to issue updates, without having to transmit several triggers. The interrupt time duration is controlled by a timer. Updating of the counters is preferably continued at expiry of the interrupt time duration or at a CFN specified for the update. The counters are preferably reset at HS-DSCH cell change, when the serving HS-DSCH cell is changed. Potential changes of ACK-NACK repetition factor is communicated with the entity scheduling the repetitions, facilitating future scheduling, as an increase of ACK-NACK repetition factor limits scheduling opportunities.

According to the second mode, new power-offset factors are applied if the number of radio link sets is changed. Preferably there are two different sets of power control related parameters (Δ_{ACK}, Δ_{NACK} and Δ_{CQI},) applied depending on the number of radio link sets. During softer handover of HS-DPCCH involving only one RBS, there is no need to trigger power offset factor update, since HS-DPCCH of different radio links are combined according to Maximum Ratio Combining.

In summary, the second mode of the invention does not require coordination between UE and Node B, but UE is updated and Node B can then be informed thereof unsynchronized, whereas the first mode of the invention requires coordination/synchronization of UE and Node B updates.

In this patent application acronyms such as UE, RBS, RNC, HSDPA, HS-DPCCH, HS-DPDCH, HS-DSCH, ADCH, are applied. However, the invention is not limited to systems with entities with these acronyms, but holds for all communications systems operating analogously.

The invention is not intended to be limited only to the embodiments described in detail above. Changes and modifications may be made without departing from the invention. It covers all modifications within the scope of the following claims.

76. A method of wireless uplink transmission control, comprising:
adjusting one or more transmission parameters of one or more wireless links not involved in soft handover in relation to one or more wireless links involved in soft handover or coordination of such parameters; and
initiating the adjustment by a radio network controller at an identified RLS size change, or at identified pre-defined error patterns received in a base station, wherein at least one of the one or more transmission parameters is a transmission power control parameter.

77. The method according to claim 76, wherein the one or more wireless links not involved in soft handover subject to adjustment of one or more transmission parameters carries high speed uplink packet data communications.

78. The method according to claim 77, wherein at least one of the one or more wireless links involved in soft handover carries uplink data communications transferred at lower speed than the high speed uplink packet data communications.

79. The method according to claim 76, wherein at least one of the one or more wireless links not involved in soft handover being subject to adjustment of one or more transmission parameters is an HS-DPCCH or HS-DPDCH of a WCDMA system.

80. The method according to claim 77, wherein at least one of the one or more wireless links involved in soft handover is a DPDCH or DPCCH of a WCDMA system.

81. The method according to claim 76, wherein at least one of one or more transmission parameters is a transmission power control parameter.

82. The method according to claim 77, wherein at least one of one or more transmission parameters is a transmission power control parameter.

83. The method according to claim 82, wherein the transmission power offset parameter indicates an offset between different uplink physical channels.

84. The method according to claim 82, wherein the transmission power offset parameter update is initiated by a radio network controller.

85. The method according to claim 82, wherein the transmission power offset parameter update is communicated according to an unsynchronized procedure.

86. The method according to claim 76, wherein at least one of one or more transmission power control parameters is a gain factor parameter.

87. The method according to claim 86 wherein the gain factor parameter is βₕₛ.

88. The method according to any of claims 76-78 wherein at least one of one or more transmission parameters is one or more parameters of hybrid ARQ.

89. The method according to any of claims 76-78 wherein at least one of one or more transmission parameters is a repetition factor parameter.

90. The method according to claim 89 wherein the repetition factor parameter is CQI repetition factor.

91. The method according to claim 89 wherein the repetition factor parameter is ACK-NACK repetition factor.

92. The method according to any of claims 76-78 wherein at least one of one or more transmission parameters is a CQI feedback cycle parameter.

93. The method according to any of claims 76-78 wherein an updating of CQI repetition factor and ACK-NACK repetition factor are initiated by first predefined distinct numbers of received consecutive CQI arrivals in error, or second predefined distinct numbers of received consecutive CQI arrivals indicated to be error-free, the first and second predefined distinct numbers being distinct for updating of CQI repetition factor and ACK-NACK repetition factor.

94. The method according to any of claims 76-78 wherein the updating of at least one of CQI repetition factor, ACK-NACK repetition factor and CQI feedback cycle is initiated if the base station either receives more than a first predefined number of consecutive CQI arrivals in error, or a second predefined number of consecutive CQI arrivals indicated to be error-free.

95. The method according to claim 94 wherein the second predefined number is greater than the first predefined number.

96. The method according to claim 94 wherein, in case the first predefined number of consecutive CQI arrivals are in error, the CQI repetition factor is increased unless the CQI repetition factor equals a maximum value CQI repetition factor.

97. The method according to claim 96, wherein the CQI repetition factor increase is an increase by one.

98. The method according to claim 96, wherein the maximum value CQI repetition factor equals four.

99. The method according to claim 96, wherein if the second predefined number of consecutive CQI arrivals are error-free, CQI repetition factor is decreased by one unless the CQI repetition factor equals a minimum value CQI repetition factor.

100. The method according to claim 99, wherein the minimum value CQI repetition factor equals 1.

101. The method according to claim 96, wherein if the first predefined number of consecutive CQI arrivals are in error, ACK-NACK repetition factor is increased by one unless the ACK-NACK repetition factor equals a maximum value ACK-NACK repetition factor.

102. The method according to claim 96, wherein, in case the second predefined number of consecutive CQI arrivals are error-free, ACK-NACK repetition factor is decreased by one unless the ACK-NACK repetition factor equals a minimum value ACK-NACK repetition factor.

103. The method according to claim 102, wherein the maximum value ACK-NACK repetition factor equals four.

104. The method according to claim 103, wherein the minimum value ACK-NACK repetition factor equals 1.

105. The method according to claim 96, wherein, if the first predefined number of consecutive CQI arrivals are in error, CQI feedback cycle factor is increased such that the resulting CQI feedback cycle factor is greater than a predefined time interval times CQI repetition factor.

106. The method according to claim 105, wherein the predefined time interval equals 2 milliseconds.

107. The method according to claim 89, wherein the transmission parameter update is initiated by a radio base station.

108. The method according to claim 89, wherein the transmission parameter update is communicated in a synchronized procedure.

109. An apparatus of wireless uplink transmission control, comprising communication means for communicating updating of one or more transmission parameters of one or more wireless links not involved in a soft handover, the communication means adapted to update being adjusted in relation to one or more wireless links involved in the soft handover or coordination of such parameters, the updating being initiated by a radio network controller at an identified RLS size change, or the updating being initiated at identified pre-defined error patterns received in a base station.

110. The apparatus according to claim 109, wherein the communications means include a transmitting means.

111. The apparatus according to claim 109, wherein the communications means are receiving means.

112. The apparatus according to claim 109, further comprising a processing means for initiating updating of one or more transmission parameters of one or more wireless links not involved in soft handover, the updating being adjusted in relation to wireless one or more links involved in soft handover or coordination of such parameters.

113. The apparatus according to claim 109, further comprising processing means for coordinating parameter updating in a first and a second apparatus.

114. The apparatus according to claim 113, wherein the first and second apparatuses are a base station and an entity of user equipment, respectively.

115. The apparatus according to claim 109, wherein the one or more wireless links not involved in soft handover subject to adjustment of one or more transmission parameters carries high speed uplink packet data communications.

116. The apparatus according to claim 115, wherein at least one of the one or more wireless links involved in soft handover carries uplink data communications transferred at lower speed than the high speed uplink packet data communications.

117. The apparatus according to claim 109, wherein at least one of the one or more wireless links not involved in soft handover being subject to adjustment of one or more transmission parameters is an HS-DPCCH or HS-DPDCH of a WCDMA system.

118. The apparatus according to claim 109, wherein at least one of the one or more wireless links involved in soft handover is a DPDCH or DPCCH of a WCDMA system.

119. The apparatus according to claim 109, wherein at least one of one or more transmission power control parameters is a transmission power offset parameter.

120. The apparatus according to of claim 119, wherein the transmission power offset parameter indicates an offset between different uplink physical channels.

121. The apparatus according to claim 119, wherein the transmission power offset parameter update is initiated by a radio network controller.

122. The apparatus according to of claim 109, wherein the transmission power offset parameter update is communicated according to an unsynchronized procedure.

123. The apparatus according to claim 109, wherein at least one of one or more transmission power control parameters is a gain factor parameter.

124. The apparatus according to claim 123, wherein the gain factor parameter is βₕₛ.

125. The apparatus according to claim 109 wherein at least one of one or more transmission parameters is one or more parameters of hybrid ARQ.

126. The apparatus according to claim 109, wherein at least one of one or more transmission parameters is a repetition factor parameter.

127. The apparatus according to claim 126, wherein the repetition factor parameter is CQI repetition factor.

128. The apparatus according to claim 126, wherein the repetition factor parameter is ACK-NACK repetition factor.

129. The apparatus according to claim 109, wherein at least one of one or more transmission parameters is a CQI feedback cycle parameter.

130. The apparatus according to claim 109, further comprising:
a processing means adapted to determine whether received CQI is considered error free or in error and in response thereupon increasing the number of error-free CQI arrivals and resetting number of consecutive CQI arrivals in error, and increasing the number of CQI arrivals in error and resetting number of consecutive CQI arrivals in error, respectively; and
a CQI processing means adapted to conditionally initiate updating of at least one of CQI repetition factor and ACK-NACK repetition factor if the base station either receives more than first predefined distinct numbers of consecutive CQI arrivals in error, or second predefined distinct numbers of consecutive CQI arrivals indicated to be error-free, the first and second predefined distinct numbers being distinct for updating of CQI repetition factor and ACK-NACK repetition factor.

131. The apparatus according to claim 109, further comprising:
a processing means adapted to determine whether received CQI is considered error free or in error and in response thereupon increasing the number of error-free CQI arrivals and resetting the number of consecutive CQI arrivals in error, and increasing the number of CQI arrivals in error and resetting number of consecutive CQI arrivals in error, respectively; and
a CQI processing means adapted to conditionally initiate updating of at least one of CQI repetition factor, ACK-NACK repetition factor and CQI feedback cycle if the base station either receives more than a first predefined number of consecutive CQI arrivals in error, or a second predefined number of consecutive CQI arrivals indicated to be error-free.

132. The apparatus according to claim 131, wherein the second predefined number is greater than the first predefined number.

133. The apparatus according to claim 131, wherein, if the first predefined number of consecutive CQI arrivals are in error, CQI repetition factor is increased unless the CQI repetition factor equals a maximum value CQI repetition factor.

134. The apparatus according to claim 133, wherein the CQI repetition factor increase is an increase by one.

135. The apparatus according to claim 133, wherein the maximum value CQI repetition factor equals four.

136. The apparatus according to claim 131, wherein, if the second predefined number of consecutive CQI arrivals are error-free, CQI repetition factor is decreased by one, unless the CQI repetition factor equals a minimum value CQI repetition factor.

137. The apparatus according to claim 136, wherein the minimum value CQI repetition factor equals 1.

138. The apparatus according to claim 131, wherein, if the first predefined number of consecutive CQI arrivals are in error, ACK-NACK repetition factor is increased by one unless the ACK-NACK repetition factor equals a maximum value ACK-NACK repetition factor.

139. The apparatus according to claim 138, wherein the maximum value ACK-NACK repetition factor equals four.

140. The apparatus according to claim 131, wherein, if the second predefined number of consecutive CQI arrivals are error-free, ACK-NACK repetition factor is decreased by one unless the ACK-NACK repetition factor equals a minimum value ACK-NACK repetition factor.

141. The apparatus according to claim 140, wherein the minimum value ACK-NACK repetition factor equals 1.

142. The apparatus according to claim 131, wherein if the first predefined number of consecutive CQI arrivals are in error, CQI feedback cycle factor is increased such that the resulting CQI feedback cycle factor is greater than a predefined time interval times CQI repetition factor.

143. The apparatus according to claim 142, wherein the predefined time interval equals 2 milliseconds.

144. The apparatus according to claim 109, wherein the apparatus is a radio network controller.

145. The apparatus according to claim 109, wherein the apparatus is a radio base station.

146. The apparatus according to claim 109, wherein the apparatus is a user equipment.

147. The apparatus according to claim 109, wherein the apparatus further comprises a communications system having a processing and storage means.

148. An apparatus further comprising a plurality of apparatuses in accordance with claim 109.
